(19) United States
(12) Patent Application Publication
(10) Pub. No.: US 2013/0045726 A1
(43) Pub. Date: Feb. 21, 2013

(54) METHOD FOR DELIVERING CALLING NAME TO A DEVICE

(71) Applicants: Jefferson STALNAKER, Conway, AR (US); Joshua Smith, Conway, AR (US)

(72) Inventors: Jefferson STALNAKER, Conway, AR (US); Joshua Smith, Conway, AR (US)

(21) Appl. No.: 13/589,510

(22) Filed: Aug. 20, 2012

Related U.S. Application Data
(60) Provisional application No. 61/525,300, filed on Aug. 19, 2011.

(51) Int. Cl. H04W 4/16

(52) U.S. Cl. 455/415

(57) ABSTRACT

The present invention is directed to an application resident on a device for receiving telephone calls which is (1) data-enabled and (2) includes a means for presenting alphanumeric characters or words. Devices which are both data-enabled and have a means for presentation may be used, such as but not limited to other smart phones, e.g., iphones, Palm Trios, and Android-enabled phones, as well as desktop, laptop, and hand-held computer devices.

### BACKGROUND OF THE PRESENT INVENTION

The present application claims priority to U.S. Provisional Patent Application No. 61/525,300, filed on Aug. 19, 2012.

In traditional voice communications, when a calling party places a call to a called party, the calling party's originating telephone number generally may be available to the called party, such as by initially being included in a signaling message used for call set up and being delivered to the terminating switch, or otherwise being known to the terminating switch for delivery to the called party.

The digits may then be delivered to the called party in an encoded in-band signaling bit stream. This set of digits, whether delivered as described or delivered in some other way, are referred to herein as “the Caller ID digits”. End user devices, including some telephones, contain the ability to decode the encoded in-band signaling bit stream and present the caller ID digits. The presentation permits the called party to pre-identify the calling party by calling number and, consequently, choose to take an action, such as to adjust their salutation or even ignore the call.

Some end devices, such as many cellular handsets, store telephone numbers and often these devices also store and associate names to each of the stored telephone numbers. In at least some of those devices, applications housed in the devices are used to display both the caller ID digits and a name associated with the caller ID digits referred to herein as the “calling party name”, as stored in the device.

It is often the case that carriers only deliver the caller ID digits without delivering the calling party name. In general, the calling party name is not delivered to cellular handsets by carriers. As a result, called parties often receive the caller ID digits without recognizing the caller's telephone number and not knowing who the calling party may be.

In general, when a called party is presented with the calling party's name, the called party can make a more informed decision regarding answering the call. With regard to some cellular devices, such as but not limited to smart phones, upon delivery of the caller ID digits, an application within the cellular device triggers a search within an on-board data store for a name to match the caller ID digits. Upon a successful match, the calling party name may be presented. In the event of no match, either the caller ID digits alone are presented or the caller ID digits with an indicator of no match is presented.

In general, the presentation is a visible display. However, some devices, such as some computers and smart phones, may have a speaker and one or more on-board text to speech applications, one of which may be used in conjunction with the speaker to audibly speak the calling party name. Audible presentation is particularly helpful when the called party is in a position to better accept audible prompts than visual prompts, such as while driving or while already on a call.

Nevertheless, if the calling party name is not delivered and is not resident in an on-board database, the calling party name is not received or presented.

### BRIEF DESCRIPTION OF THE INVENTION

The present invention overcomes the aforementioned drawback by leveraging additional otherwise unconnected data stores of calling names and associated telephone numbers such that the calling party name may be delivered and displayed on the device receiving the call or on an associated device. In particular, the present invention is directed to delivery and presentation of a calling party's name or other alphanumeric identifier to a called party, when the calling party name would otherwise be unavailable to the called party. The calling party name is delivered to the called party's device and presented to the called party soon after the first ring, typically in concert with the call being delivered. The present invention requires the called party's receiving device to be a data-enabled receiving device, such as but not limited to a computer or a smart phone.

In addition, the present invention is also directed to visually presenting the received calling party name, audibly presenting the received calling party name, or both. Also, the present invention is directed to giving the receiving party the opportunity to store the received calling party name in an on-board data store for later use.

The present invention involves an application resident on the device receiving the call, where the device is capable of communicating with remote servers or other devices during the time the call is being received. In the time immediately following the presentation of the call to the called party, namely, at or soon after the first ring, and independent of any action by the called party, a query is prepared within the receiving device or associated device and sent to a remote server for a name corresponding to the caller ID digits. In the present invention, upon receiving the caller ID digits, the application on the receiving device initially polls a resident data store (“the address book”) for the associated calling party name. If the search does not identify a database entry associated with the caller ID digits, then a query is sent to a remote server, from which several selected databases may be polled for a match. These databases are databases containing records which, at least in part, correspond to associations between telephone numbers and names. In the event one of the remote databases contains a record with the caller ID digits and a matching calling party name, the calling party name is returned to the application in the receiving device, from which the calling party name is presented (visually and/or audibly), the user can determine the appropriate action such as to answer or to ignore, and the user is given the opportunity to store the calling party name in a database resident on the device.

### BRIEF DESCRIPTION OF THE FIGURE

FIG. 1 shows a flow chart depicting the process steps of an application on a smart phone or other telephonic device which is employing the present invention.

FIG. 2 shows a flow chart of the process steps performed by a server in communication with the application of FIG. 1.

### DETAILED DESCRIPTION OF THE INVENTION

The present invention is directed to an application resident on a device for receiving telephone calls which is (1) data-enabled and (2) includes a means for presenting alphanumeric characters or words. Although in the preferred embodiment the device is a Blackberry smart phone, other devices which are both data-enabled and have a means for presentation may be used, such as but not limited to other smart phones, e.g., iphones, Palm Trios, and Android-enabled phones, as well as desktop, laptop, and hand-held computer devices.

The data-enablement of the device can take a number of forms. Preferable the device is wirelessly enabled for internet access, although the device may have a wired connection as well. The data channel is preferably a private channel, such as a channel carried across a carrier's own data network or may be a channel using the public internet, or a combination.

The means for presentation may take any number of forms. In the preferred embodiment, the presentation takes the form of a visual display. Alternatively, the presentation may be audible, or a combination of visual and audible.

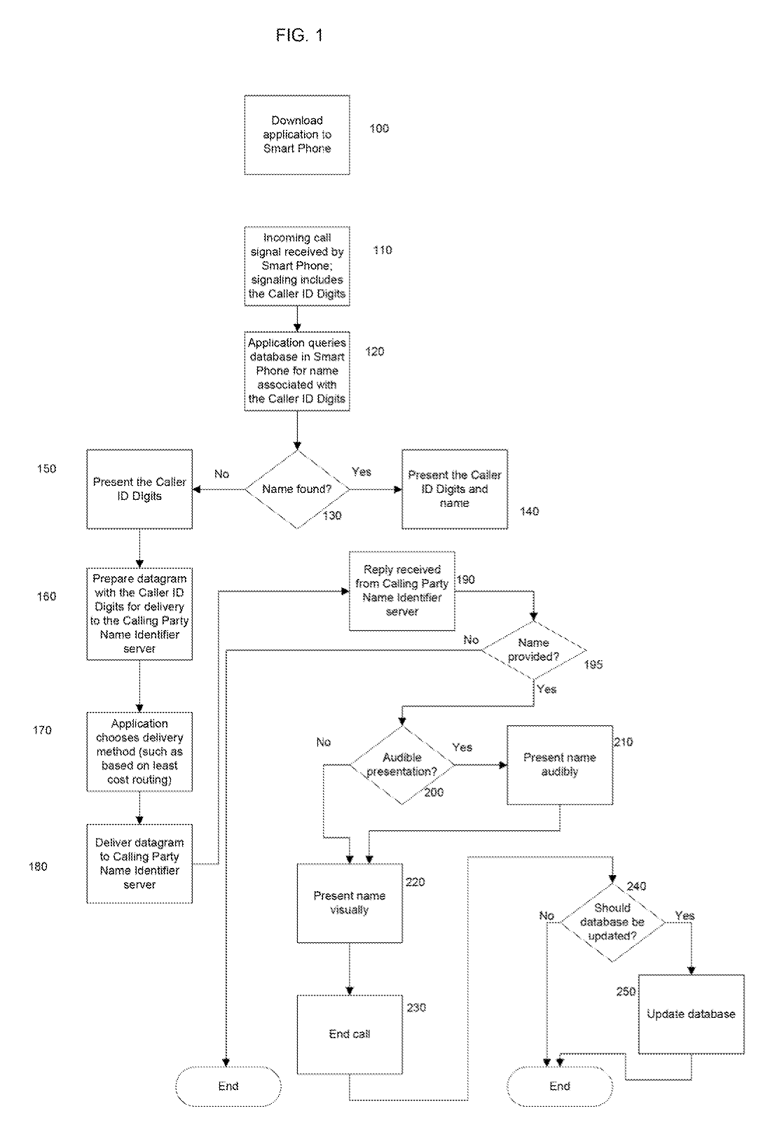

With reference to FIG. 1, in the present invention a smart phone, such as a Blackberry telephonic device, an iphone, or similar device, is initially provided with an application 100. Typically the application is loaded onto the device using traditional downloading methods. The present invention leverages one or more of the device's internal databases, such as the address book, as well as data access means.

The method of the present invention commences upon the device receiving signaling information 110 that an incoming call is awaiting pick up or disposition. Typically, such information is presented as an audible ring, another audible indicator such as a call waiting tone, and/or a visual display indicating that the incoming call is waiting for disposition. In addition, the caller ID digits are delivered within the signaling information of the incoming call awaiting pick up and, if delivered, are presented to the called party.

Upon receipt of the incoming signaling message, the application of the present invention queries databases in the receiving device for any name associated with the caller ID digits 120. If a name is found, the name is extracted and presented 140. The presentation may be audible, visual, or both, If no name is found, merely the caller ID digits are presented 150.

In addition to presenting the caller ID digits, the application of the present invention prepares a datagram for delivery to a remote server (referred to herein as the “Calling Party Name Identification server”) 160. This datagram includes, but is not necessarily limited to, the caller ID digits, data indicating the particular receiving device or smart phone, and authentication data for proper querying of the Calling Party Name Identification server. In addition to preparing the datagram, the application also selects a path for transport of the datagram 170. This selection may be based on a variety of factors, such as data service paths available at that moment in time or least cost routing, and could include private data paths or the public internet. Access to the public internet may use a variety of means, including but not limited to a wireless fidelity (“WWI”) channel, a wired public or semi-public network, or dedicated private facilities. The datagram is then delivered to the Calling Party Name Identification server 180.

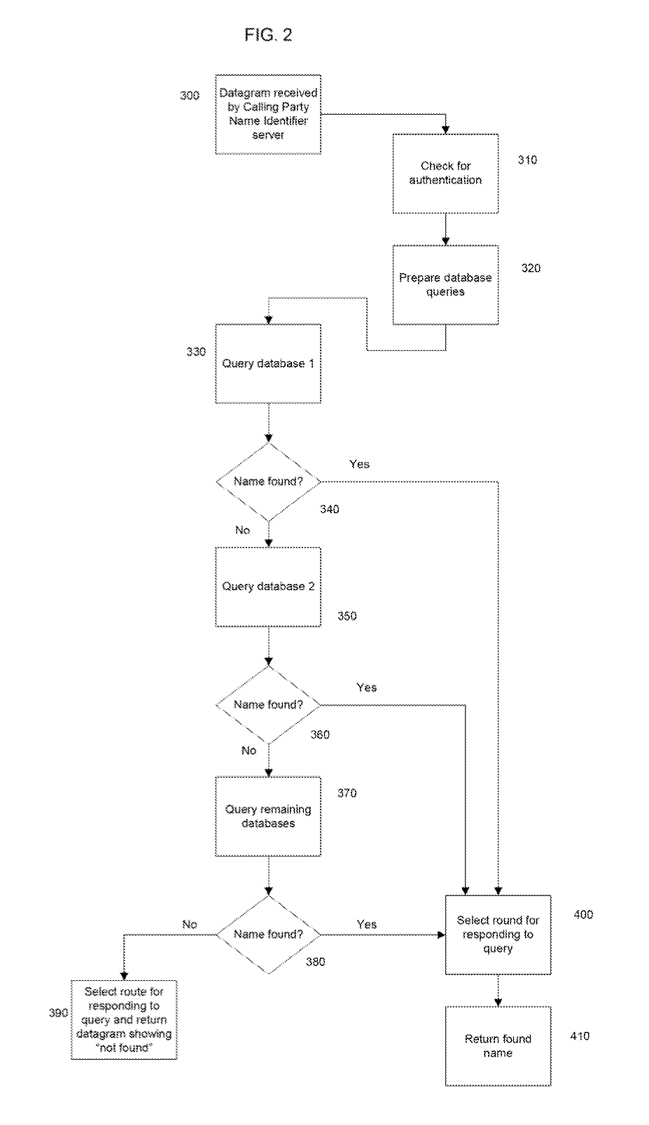

Referring to FIG. 2, which shows a flow chart of the functions performed within the Calling Party Name Identification server, the Calling Party Name Identification server has the ability to communicate with one or more databases and may query a plurality of databases sequentially or in parallel. Upon the Calling Party Name Identification server receiving the aforementioned datagram from the smart phone 300, the Calling Party Name Identification server may authenticate the smart phone 310 to assure that the smart phone is registered with a proper subscriber. The Calling Party Name Identification server then prepares database queries 320. Each of these queries includes the caller ID digits and query for an associated name. The Calling Party Name Identification server then queries a first database 330. If an associated name is found, that name is returned to the Calling Party Name Identification server 400. If the name is not found, a second database 350 is queried. Similarly, an associated name is found, that name is returned to the Calling Party Name Identification server 400. Otherwise, the process is repeated over all available databases that are known by the Calling Party Name Identification server to associate names with telephone numbers. Once a matching name is identified and returned to the Calling Party Name Identification server, the Calling Party Name Identification server prepares a response message to the query which originated with the smart phone and delivers the message to the smart phone based upon the original routing to it.

If no match is found, a message is returned from the database to the Calling Party Name Identification server indicating that no name was found 390.

Returning to FIG. 1, upon receipt of the reply from the Calling Party Name Identification server 190, the application determines if a name is delivered 195. If a name is not delivered, the process ends. If a name is delivered, the application determines if the presentation of the response should be audible 200. If an audible presentation is not required, a visual presentation 220 is made. If an audible presentation is required, an audible presentation 210 is made followed by visual presentation 220.

When the call completes 230, the application queries the user as to whether the on-board address book or another database should be populated with any delivered calling party name information. If yes, the application updates the appropriate on-board database 250.

The calling party name data from the Calling Party Name Identification server obtained via the smart phone's data connection will be stored within an application in the smart phone and identified by a unique reference ID. The application will then make the necessary API calls within the device for interacting with a call screen API. The interaction with a call screen API will vary from between device manufactures and operating systems and be used for display purposes.

While this invention has been particularly shown and described with references to preferred embodiments thereof, it will be understood by those skilled in the art that various changes in form and details may be made therein without departing from the scope of the invention encompassed by the appended claims.

1. Using a mobile communication device comprising a processor, a data store, a presentation engine, and a displayer; a method to display a label representing a name of a calling party, comprising the steps of:
during a time period of notification of an incoming call, receiving a datagram comprising a ten digit string representing the incoming calling party number,
said processor searching said on-board data store for a label for said ten digit string and, if found, delivering said label to said presentation engine, and if not found, using a network, sending a query comprising said ten digit string for a label to a server, receiving a response, and delivering said response to said presentation engine, and
said presentation engine formatting said label and delivering said label to said displayer for display.

2. The method of claim 1, where the label returned in the response to said query is further used to update said on-board data store.

3. The method of claim 1, where said presentation engine formats said label to a visual representation and the displayer is a visual display.

4. The method of claim 1, where said presentation engine formats said label to an audio representation and the displayer is an audio display.

5. The method of claim 1, where said ten digit string is the caller ID of the calling party.

6. The method of claim 1, where said label represents the name of a subscriber associated with said ten digit string,

7. The method of claim 1, where said query and said response are transported over at least one of GSM, 4G, or LTE networks.

8. The method of claim 1, where said query is launched by an application previously downloaded to said mobile communication device.

9. The method of claim 1, where said mobile communication device is a smart phone.

10. The method of claim 1, where said mobile communication device is a tablet computing device.

11. The method of claim 1, where the type of display is selectable by a user of the mobile communication device.

12. Using a mobile communication device comprising a processor, a data store, a presentation engine, and a displayer; a method for updating a data store comprising the steps of:
during a time period of notification of an incoming call, receiving a datagram comprising a ten digit string representing the incoming calling party number,
preparing a query for a label directed to a remote server and comprising said ten digit string,
transmitting said query to said server,
receiving in response a label for said ten digit string,
delivering said label to said presentation engine,
presenting said label for display, and
updating an on-board data store with said label.

13. The method of claim 12, where said ten digit string is the caller ID of the calling party.

14. The method of claim 12, where said label is the name of a subscriber associated with said ten digit string.

15. The method of claim 12, where said query and said response are transported over at least one of GSM, 4G, or LTE networks.

16. The method of claim 12, where said query is launched by an application previously downloaded to said mobile communication device.

17. The method of claim 12, where said mobile communication device is a smart phone.

18. The method of claim 12, where said mobile communication device is a tablet computing device.

19. The method of claim 12, where the type of display is selectable by a user of the mobile communication device.

20. A mobile communication device for storing and displaying a label, said label received in response to a query for a name associated with a numeric string, comprising:
a data store for storing labels and associating said each label with a numeric string,
transmit and receive means for communicating with a remote server using a communications network,
a displayer for displaying a received label, and
a processor in communication with said data store, said transmit and receive means, and said displayer.
